(19) United States
(12) Patent Application Publication
(10) Pub. No.: US 2014/0295733 A1
(43) Pub. Date: Oct. 2, 2014

(54) BEE TRANSPORTATION SYSTEM

(71) Applicants: Mindy Anne WAITE, Grantsville, UT (US); Jason R. WAITE, Grantsville, UT (US); Michael S.J. WELLS, Stansbury, UT (US); Rhonda L. WELLS, Stansbury, UT (US)

(72) Inventors: Mindy Anne WAITE, Grantsville, UT (US); Jason R. WAITE, Grantsville, UT (US); Michael S.J. WELLS, Stansbury, UT (US); Rhonda L. WELLS, Stansbury, UT (US)

(21) Appl. No.: 14/228,123

(22) Filed: Mar. 27, 2014

Related U.S. Application Data
(60) Provisional application No. 61/806,135, filed on Mar. 28, 2013.

(51) Int. Cl. A01K 47/06

(52) U.S. Cl. CPC A01K 47/06
USPC 449/13

(57) ABSTRACT

A bee transportation system is configured to ship a bee box and has a bee container having a front side and a rear side and further configured to accommodate the bee box and the feeder can. At least one front ventilation port is arranged on the front side and configured to permit air to pass through the bee container and the bee box. At least one rear ventilation port is arranged on the front side and configured to permit the air to pass through the bee container and the bee box. Flaps are mechanically coupled to the bee container and configured to hold the feeder can in place. The bee container creates an insulated environment for the bee box. The ventilation ports are configured to prevent bee stingers from extending through the ventilation ports which prevents injuries.

### RELATED APPLICATION

This application claims priority to provisional patent application U.S. Ser. No. 61/806,135 filed on Mar. 28, 2013, the entire contents of which is herein incorporated by reference.

### BACKGROUND

The embodiments herein relate generally to devices for transporting bees.

As used in this application “bees” are a monophyletic lineage within the superfamily Apoidea, presently classified by the unranked taxon name Anthophila. Scientific classification of bees is somewhat controversial, but this application refers to any of the presently 20,000 known species of bees which can be used for honey production.

Prior to the disclosed invention, attrition of bees in transport escaped a simple solution. Bee stings are unpleasant, as a result, bees must be shipped in a manner to avoid having handlers of containers of bees stung. Prior art bee shipping containers involve a costly and excessive amount of material to meet shipping carrier guidelines. The present invention solves this problem.

### SUMMARY

A bee transportation system is configured to ship a bee box containing bees and a feeder can in an insulated environment that is configured to prevent injuries such as bee stings. The bee transportation system includes a bee container having a front side and a rear side and further configured to accommodate the bee box and the feeder can. At least one front ventilation port is arranged on the front side and configured to permit air to pass through the bee container and the bee box. At least one rear ventilation port is arranged on the front side and configured to permit the air to pass through the bee container and the bee box. Flaps are mechanically coupled to the bee container and configured to hold the feeder can in place. The bee container creates the insulated environment. The at least one front ventilation port and the at least one rear ventilation port are configured to prevent bee stingers from extending through the at least one front ventilation port and the at least one rear ventilation port which prevents the injury.

In some embodiments, the at least one front ventilation port and the at least one rear ventilation port are made from galvanized hardware cloth of 8 mesh 27 gauge which prevents stops the bee stingers while ensuring ventilation to keep the bees alive. The bee container further comprises a bottom side that is reinforced in order to hold the bee box in place. The bee container is made from wax coated cardboard that insulates the bee box keeping at a more constant temperature than uninsulated materials.

The bee container can further comprise exterior markings that indicate the bees are present. The exterior markings can further indicate that the bee container needs to be oriented in a specific direction in order to enable the bees to access the feeder can. The exterior markings can further indicate that spacing a first bee container at least one foot from each other bee container will permit the air to keep the bees alive. The exterior markings can further indicate that the bee container should be kept out of direct sunlight in order to avoid increasing a temperature within the bee container which is a cause of bee death.

### BRIEF DESCRIPTION OF THE FIGURES

The detailed description of some embodiments of the invention is made below with reference to the accompanying figures, wherein like numerals represent corresponding parts of the figures.

FIG. 1 is a front perspective view of an embodiment of the invention.

FIG. 2 is a rear view of an embodiment of the invention.

FIG. 3 is a front detail perspective view of an embodiment of the invention demonstrated with the container flaps in open configuration.

FIG. 4 is an exploded view of an embodiment of the invention.

### DETAILED DESCRIPTION OF CERTAIN EMBODIMENTS

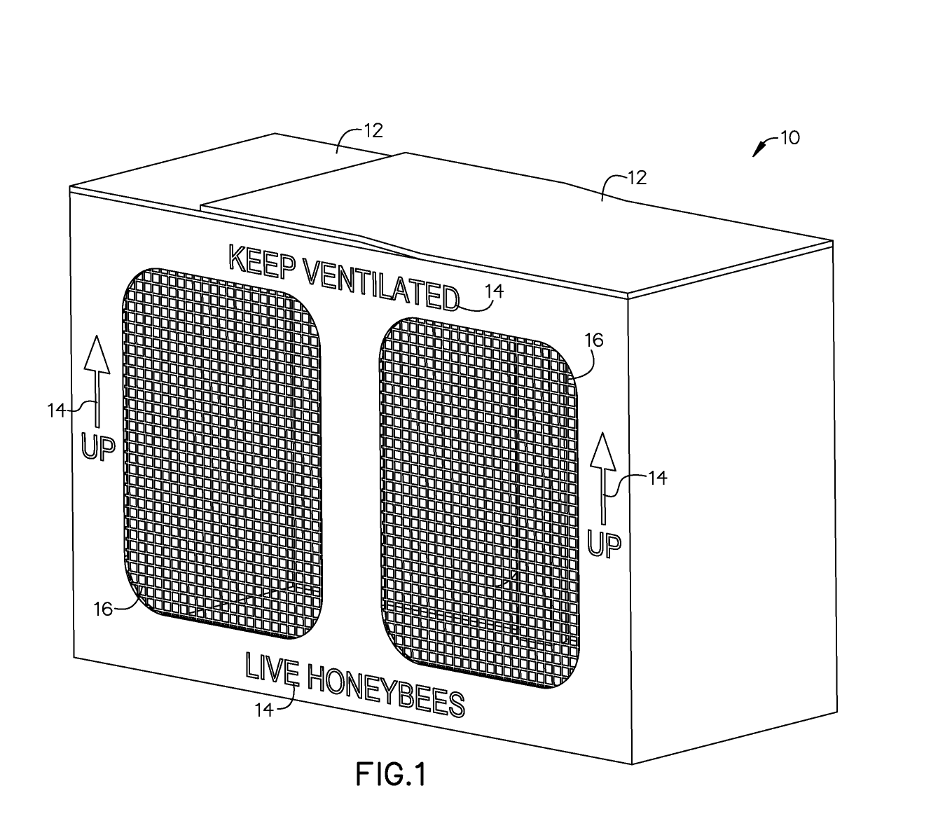

By way of example, and referring to FIG. 1, one embodiment of the present system comprises bee container 10. Bee container 10 comprises a modified parallelepiped having a partially open end. The partially open end is covered with flaps 12 mechanically coupled to the modified parallelepiped. In some embodiments, the modified parallelepiped is made from wax coated cardboard. This material is particularly effective because it keeps the bees at a more constant temperature than uninsulated materials or materials with less insulation. This creates an insulated environment. In some embodiments, flaps 12 are mechanically coupled to the modified parallelepiped with hot glue.

A front side of the modified parallelepiped can be marked with exterior markings 14 indicating 1) live bees are present. In the broader sense, of the bee transportation system live honeybees need to be marked when in a container. 2) the upward arrow and text indicates that bee container 10 needs to be oriented in a specific direction in order to enable the honey bees to access feed can 30 as shown below. 3) The ventilation notification seeks to encourage spacing a first bee container 10 at least one foot from each other bee container 10 in order to permit air to flow through each bee container 10.

To aid in this regard, the front side is perforated in two places mechanically coupled to front ventilation ports 16. In some embodiments, each ventilation port 16 further comprises galvanized hardware cloth of 8 mesh 27 gauge. This material is important because it allows air to flow through bee container 10 cooling the bees inside and keeping the bees alive longer. Likewise, the rear side is perforated in two places mechanically coupled to rear ventilation ports 16. This better increases the flow of air. Further, there will be a boundary through which bee stingers cannot permeate in bee container 10, this prevents injury to transportation personnel and also reduces transportation costs as a bee premium is attached to shipping bees without such bee container 10.

In some embodiments, a bottom side on bee container 10 can be reinforced with several layers of wax coated cardboard. This ensures that the bottom side is strong enough to support bee box 20.

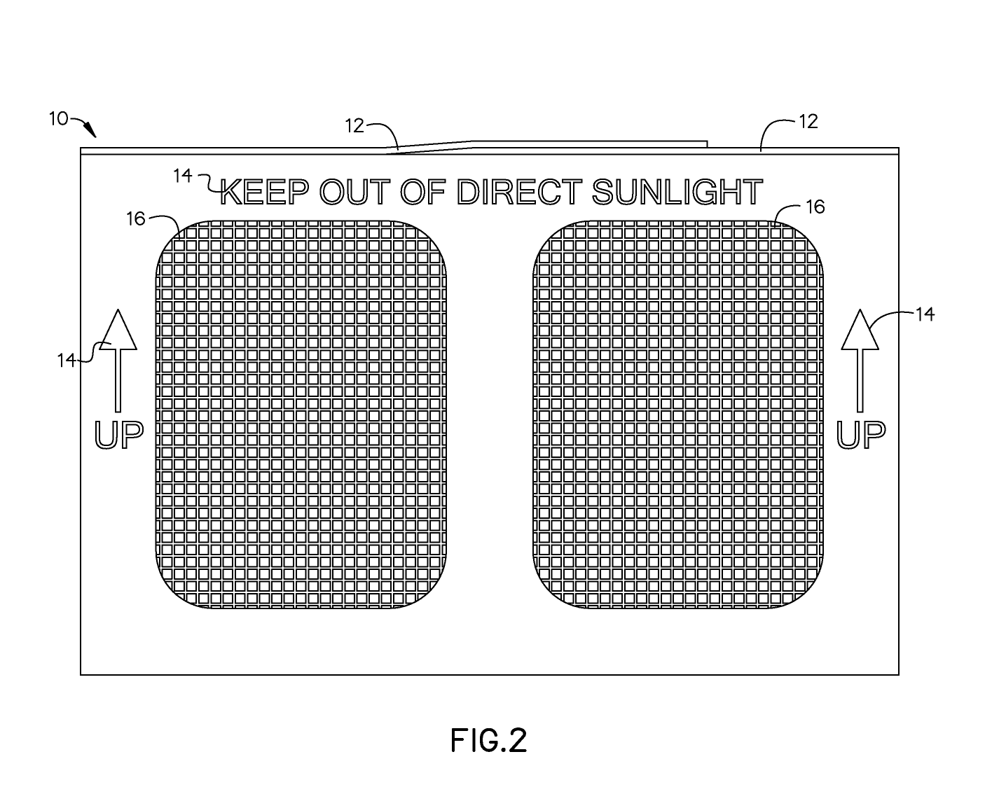

FIG. 2 shows the back side of bee container 10. The back side of the modified parallelepiped can be marked with exterior markings 14 indicating 1) the upward arrow and text indicates that bee container 10 needs to be oriented in a specific direction in order to enable the honey bees to access feed can 30 as shown below. 2) Bee container 10 should be kept out of direct sunlight in order to avoid increasing the temperature of bee container 10 which is a cause of bee death.

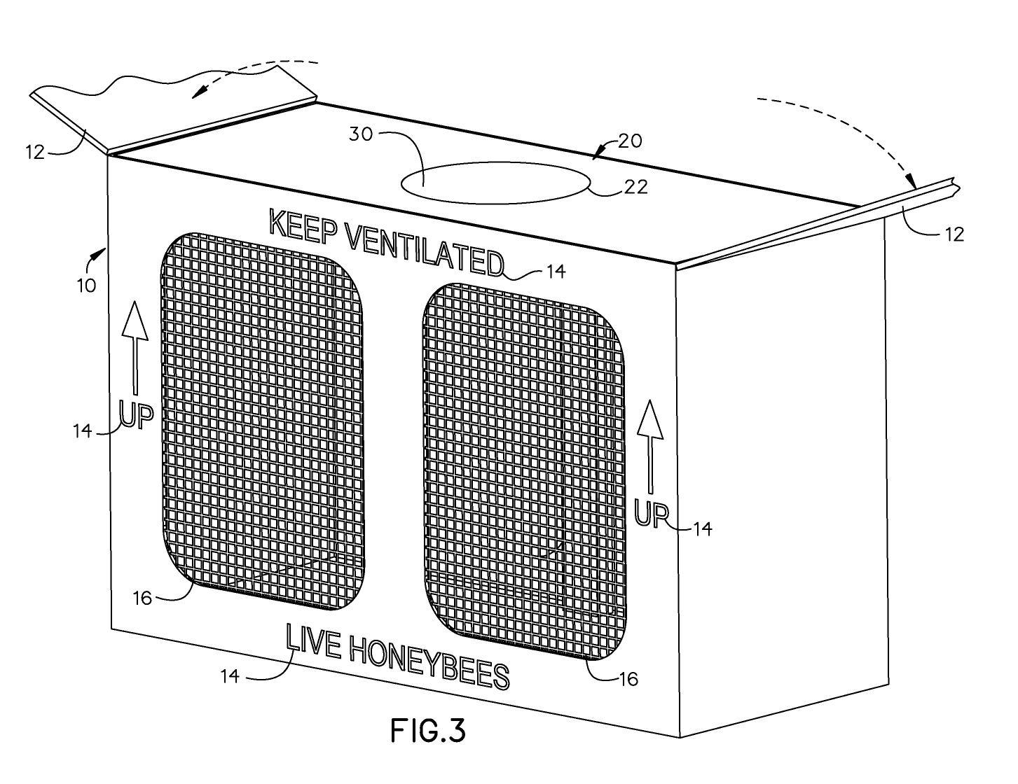

As shown in FIG. 3, bee container 10 is configured to accommodate bee box 20. Bee box 20 comprises fee can receiver 22 which is configured to accommodate feed can 30. Feed can 30 contains some kind of sugar or other feed to further assist in keeping the bees alive in transit. Typically, bees are purchased in bulk and likewise sold in bee box 20 made from wood having grating 24 mechanically coupled to a bee box front side and a bee box rear side. However grating 24 is ineffective at both insulating bee box 20 and preventing handlers from being stung.

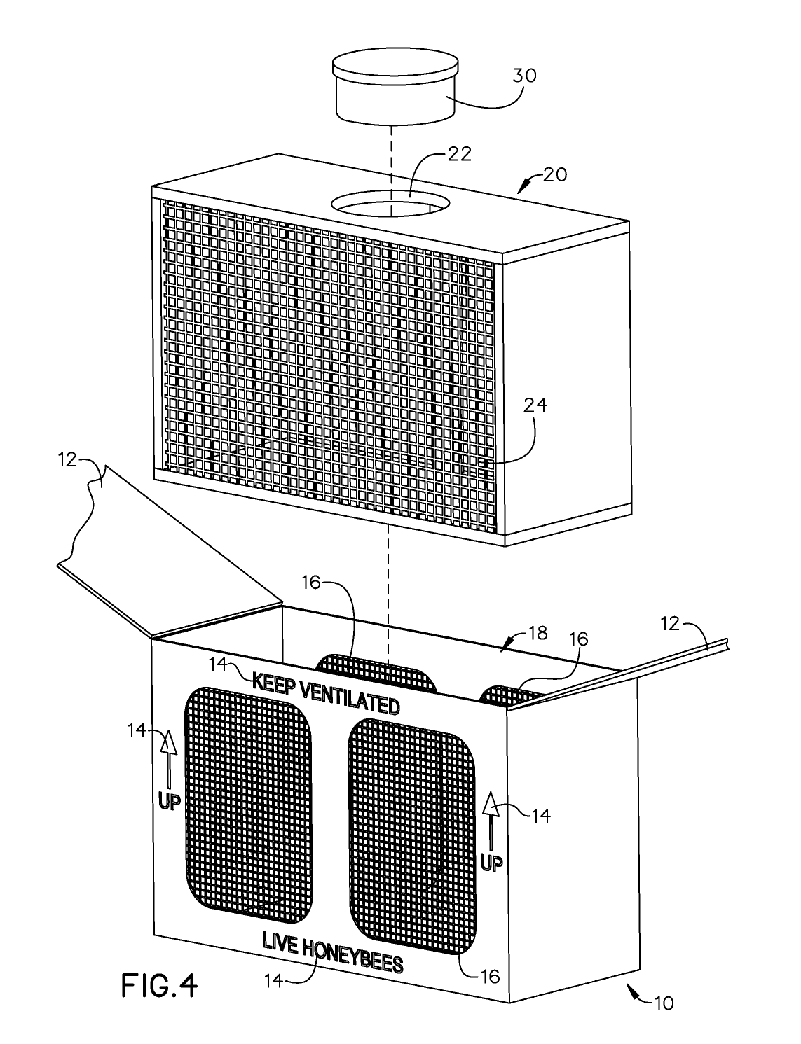

As shown in FIG. 4, to use the bee transportation system, first obtain bee box 20 with contestant ventilation and air flow from the wholesale beekeeper. Next, bee boxes 20 are stored and cooled to 65 degrees, feeder cans 30 are replaced and re-filled at the local storage facility. After that bees on outside of grating 24 are cleared from bee box 20. Then bee box 20 is placed into bee container 10, flaps 12 are folded or glued over bee box 20 further holding feeder can 30 into place. Finally, bee container 10 is shipped. Experimentation in using bee container 10 versus simply using bee box 20 has indicated that bee box 20 results in about 20%-50% of bees being killed in transit whereas bee container 10 results in less than 5% of bees being killed in transit and, in many cases, all bees survive.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A bee transportation system, configured to ship a bee box containing bees and a feeder can in an insulated environment that is configured to prevent injury; the bee transportation system comprising:
a bee container having a front side and a rear side and further configured to accommodate the bee box and the feeder can;
at least one front ventilation port arranged on the front side and configured to permit air to pass through the bee container and the bee box;
at least one rear ventilation port arranged on the front side and configured to permit the air to pass through the bee container and the bee box;
flaps mechanically coupled to the bee container and configured to hold the feeder can in place;
wherein the bee container creates the insulated environment;
wherein the at least one front ventilation port and the at least one rear ventilation port are configured to prevent bee stingers from extending through the at least one front ventilation port and the at least one rear ventilation port which prevents the injury.

2. The bee transportation system of claim 1, wherein the at least one front ventilation port and the at least one rear ventilation port are made from galvanized hardware cloth of 8 mesh 27 gauge which prevents stops the bee stingers while ensuring ventilation to keep the bees alive.

3. The bee transportation system of claim 1, wherein the bee container further comprises a bottom side that is reinforced in order to hold the bee box in place.

4. The bee transportation system of claim 1, wherein the bee container is made from wax coated cardboard that insulates the bee box keeping at a more constant temperature than uninsulated materials.

5. The bee transportation system of claim 1, wherein the bee container further comprises exterior markings that indicate the bees are present.

6. The bee transportation system of claim 5, wherein the exterior markings further indicate that the bee container needs to be oriented in a specific direction in order to enable the bees to access the feeder can.

7. The bee transportation system of claim 6, wherein the exterior markings further indicate that spacing a first bee container at least one foot from each other bee container will permit the air to keep the bees alive.

8. The bee transportation system of claim 7, wherein the exterior markings further indicate that the bee container should be kept out of direct sunlight in order to avoid increasing a temperature within the bee container which is a cause of bee death.
